(19) United States
(12) Patent Application Publication
(10) Pub. No.: US 2010/0196565 A1
(43) Pub. Date: Aug. 5, 2010

(54) Sanitizing of Transported Food Product by Spray Application of Sanitizing Material in an Auger System to Increase Surface Coverage of said Product by said Sanitizing Material during Transport

(76) Inventors: Battle Glascock, Soddy Daisy, TN (US); Robert Bullard, Single Mountain, TN (US)

Correspondence Address: DOWELL & DOWELL P.C., 103 Oronoco St., Suite 220, Alexandria, VA, 22314, US

(21) Appl. No.: 12/696,120

(22) Filed: Jan. 29, 2010

Related U.S. Application Data
(60) Provisional application No. 61/202,136, filed on Jan. 30, 2009.

(51) Int. Cl. A23B 4/26; A23L 3/3454

(52) U.S. Cl. 426/310; 99/516

(57) ABSTRACT

The process and apparatus of the present invention is directed to an auger system that continuously sanitizes transported food products prior to processing and consumption. The auger system is designed to increase and enhance the surface and sub-surface area exposure of a transported food product to a liquid and/or gaseous sanitizing material. The auger system includes specialized flights and attachments for the agitation and/or turning of the transported food product to affect the sanitizing process by exposing a substantial portion of the surface of the transported food product to the liquid and/or gaseous sanitizing material.

### CROSS-REFERENCE TO RELATED APPLICATIONS

This application claims the benefit, under 35 U.S.C. 119(e), of U.S. Provisional Application No. 61/202,136 filed Jan. 30, 2009, the contents of which are incorporated herein by reference.

### BACKGROUND OF THE INVENTION

1. Field of the Invention

The present invention relates to a process and apparatus for the continuous sanitizing of a transported food product using a specialized auger system.

2. Description of Related Art

Food products, and more specifically protein based foods, have a natural affinity to promote the growth of harmful microbiology. Protein based foods can become contaminated from a variety of sources during processing. Continual cleaning and sanitizing of the processing machinery, employees and product is required to keep microbiology under control.

Harmful microorganisms are transported by air, water, feces, feeds, hides, intestines, lymph nodes, processing equipment, utensils and humans, and contribute to the microbial contamination of the meat products during slaughter, fabrication and further processing and handling. (Bell, 1997; Gill, 1998; Sofos, 1994). Based on studies conducted by Sofos, it was shown that animal products, including carcasses and fresh meat, are contaminated with microorganisms and support their growth if not properly handled, processed and preserved (Sofos, 1994; Sofos et al, 1999). Extensive contamination, or abusive conditions of handling and storage that promote microbial proliferation, increase the potential for the presence of pathogenic bacteria and formation of toxins, and may lead to product spoilage and public health problems.

Microbes of all kinds have a dramatic effect on the quality and safety of the food supply chain. They are naturally occurring biological organisms that must be taken very seriously by the food producer in order to maintain a safe supply of consumable goods. Each has its own characteristic morphology and biological activity. They are a major component of the natural biology on earth and can be found in various forms on the hides and in the storage pens of the meat processing facility. One of the primary and most dramatic influences they all have in common is their potentially harmful effects to the food supply chain and more specifically, through their contamination of meat products as referenced above, to the human consumer.

Food poisoning affects some 60 to 80 million people each year and results in approximately 8 thousand deaths each year in the United States alone. Salmonella alone cost approximately $1 billion a year in medical costs and lost time on the job, according to the Centers for Disease Control and Prevention. Food quality and the real potential for food poisoning resulting from bacterial contamination of meat products are concerns shared by both food producers and consumers. Due to the modernization of manufacturing and transportation systems, it is now possible to supply increasing demands for meat products from fewer, but larger, manufacturing facilities. A pathogenic bacterial outbreak in one of these larger facilities could lead to a significantly large number of people exposed to the harmful effects of these very aggressive and harmful microorganisms.

Protein based food products are continuously exposed to sanitizing processes in order to minimize or eliminate microbiological loads on the product surface. Contamination occurs when the protein material's outer surface is exposed to any of the pathogen sources listed above. Once contaminated, the product must be subjected to a sanitizing intervention in order to control the growth of the microorganism. The primary concern is the location of the microbiology on the outer surface of the protein based materials. Typically, harmful bacteria do not reside below the surface of the product and is only introduced during the processing of the product by external means. It is therefore critical to the safe supply of food to the consumer that the outer surface of protein based materials be clean and processed in sanitary conditions throughout the production process.

Federal, state and local agencies share the responsibilities for monitoring and ensuring that the food processor adheres to strict guidelines for food safety during production. The processor must develop and follow a Prerequisite Sanitation Program such as Good Manufacturing Practices (GMP), Standard Operating Procedures (SOP) and Sanitation Standard Operating Procedures (SSOP) that comply with the federally mandated sanitation guidelines so that they provide the foundation for food safety in the plant environment.

Once these programs are in place, the manufacturer can develop additional food safety programs within their processing facilities that build on the basic foundation of the mandated operational procedures. The plant voluntary sanitation procedure is referred to as their Hazard Analysis and Critical Control Point (HACCP) program.

The processors HACCP program is extremely important to the attainment of a safe food supply and builds on the GMP, SOP and SSOP for daily operations and biohazard control within the production facility. The HACCP program targets processes and procedures that have a potential to impart biological hazards in the food production process with the implementation of sanitation chemistries and processes that will control or prevent the outbreak of a biological hazard. Typical points of application for sanitation chemistries are known as intervention sites. As various operations within the facility are recognized as high risk for possible biohazards, an intervention process or procedure is developed by the plant to directly affect the potential risk. Once an intervention process or procedure is developed and found to be effective, it is made part of the plant HACCP program.

Various methods of intervention are employed throughout the entire production process. Historically, the methods used to control harmful bacteria within the high volume processing facility have been based on a surface contact approach. A majority of the new technologies available have been applied directly onto the outer surface meat products being produced, as well as to the machinery surfaces and plant walls and floors that are subject to microbial build-up. These applications or intervention sites generally utilize water-based chemistry or gaseous material to control microbiological growth.

Various chemistries have been developed and used over the years for sanitizing and intervention processes for protein based food products. No matter what chemistry it utilized, exposure of the outer surface of the transported material to this chemistry to assure complete contact with the sanitizing material is a prerequisite to attainment of proper sanitizing efficacy.

Each sanitizing chemistry or process also requires a certain time of exposure to allow the process to affect and cause a significant reduction in microbiology. Even with all of the sanitizing efforts developed thus far, there are still unexplainable intermittent microbiological outbreak events within the production facility.

Re-contamination of meat and processing surfaces is the result when inefficient sanitizing processes are employed and therefore continual efforts are expelled in an attempt to maximize the sanitizing program to reduce the potential for harm to the consumer.

Typical sanitizing processes utilize a liquid or gaseous material as a means to reduce bacterial load on the surface of food products during the processing. Sanitizing processes vary in design and application but all require the use of a sanitizing material, either in liquid or gaseous form, or temperature, for surface exposure of the material being processed. The time of exposure of the outer surface of a protein based material directly affects the sanitizing process efficiency and therefore the more surface exposure a food product has to a sanitizing material during processing, the higher the degree the bacteria destruction efficiency will be.

Typical applications utilize a liquid immersion bath or a spray application over the surface of the food material. Liquid baths provide a high surface coverage but are limited in application due to regulatory constraints, process cost and complexity. Spray applications of sanitizing material are significantly more efficient as far as cost of equipment is concerned but do not provide the surface coverage that a liquid bath does and significant amounts of sanitizing material are used to affect a relatively small area of the food product.

Liquid immersion of a meat product is a very effective way to reduce the pathogen loads on the meat surface because this method typically provides complete surface exposure of the product to a sanitizing chemistry. It also provides a fairly high degree of agitation of the product as it floats and separates each individual piece of meat and moves them from one end of an immersion tank to another. The primary issue is the difficulty in application of this process as a continuous process. There are also regulatory control and restrictions by the USDA in the application of a liquid immersion process on certain types of meat. Material handling in a continuous immersion bath is very difficult to implement and requires very expensive equipment and space to employ. There is also the possibility of recontamination of the product if the bath chemistry is not properly treated and maintained. Batch processing in an immersion bath is not practical based on the high production rates required and therefore the wide spread use of this type of intervention is limited. The primary benefit of a liquid bath immersion system is the fact that the entire surface of the product is exposed to the sanitizing material and thus the pathogen kill rate is much higher than typical spray applications. Liquid immersion typically exposes all outer surfaces to the sanitizing materials as the material is “floated” through the process unless a portion of the material is shielded from exposure by a support conveyor or some other masking means employed in the transport of the product.

Spray application of sanitizing materials is much easier to implement as that it allows for an easy installation and provides relatively high surface coverage for areas of the product that are exposed to the spray stream. The primary problem is that the material handling means employed during the spray application typically shields a large portion of the outer surface of the product and thus the bacterial load in these areas is not subjected to the sanitizing chemistry. Skin and meat flaps as well as loose fat and cuts caused by the evisceration process can shield contamination from a sanitizing spray system.

Flat belt conveyors are used extensively to transport the product from one process to another and offer a very easy intervention site for spray applications of sanitizing material. The problem is that meat products are typically lumped together on a belt type conveyor and the meat product is lying flat on the belt or against a transport conveyor flight thus shielding these areas from direct spray of the sanitizing material. Little to no agitation or lump disruption of the product as it is transported and sprayed with sanitizing material increases the total area of the material that goes untreated in the sanitizing system.

Flat belt or typical auger systems are employed to move high volumes of materials from one process to another and from one level to another throughout the processing facility. If the pathogen load on the surface of the product is not treated or is shielded from exposure to sanitizing chemistry, the pathogen continues to grow and re-contaminates the product and subsequent processing machinery as it continues down the processing line. This is especially true when considering the processing of ground meats for sausage, hamburger, or any other food product where cut meats are ground up for a particular use. At issue is the probable contamination of the entire ground mass once a piece of contaminated product is ground together with other meat parts in the grinders used for the preparation of ground products. If any surface of a particular piece of meat is contaminated with E. coli, for example, the entire inner mass of ground material is thus potentially exposed to the microbiology. Once processed in a grinder, it is impossible to kill the contaminant by typical surface sanitizing means. According to the USDA and in response to several well publicized outbreaks of E. coli in ground beef in the 1980s and 1990s, cooking ground beef to an internal temperature of at least 160° F. will eliminate the harmful effects of the bacteria and in fact is a requirement for serving the public cooked ground meat products.

The high volume production processes used in today's food supply industries necessitate the use of continuous sanitizing processes that do not require additional labor or complex and expensive application system to affect the process. A need exists for a system that will allow for a complete exposure of a food material to a sanitizing material in a continuous system that does not employ liquid bath submersion.

### BRIEF SUMMARY OF THE INVENTION

One of the many advantages of the present invention is the reduction in the harmful effects bacteria have on certain industries and processes, and a method by which their effects on food safety can be attenuated. In agricultural industries, and more specifically in the high output production of beef, poultry, fish and pork, the control of microorganisms on the surface of the food products being handled in the processing facility, is of primary concern.

The process and apparatus of the present invention is directed to an auger system that continuously sanitizes transported food products prior to processing and consumption. The auger system is designed to increase and enhance the surface and sub-surface area exposure of a transported food product to a liquid and/or gaseous sanitizing material. The auger system provides a method for the partial or complete submersion of the transported food product in a sanitizing solution while subjecting the same to a continuous shower of a liquid and/or gaseous sanitizing material for the promotion of surface contact by the sanitizing material. The exposure area of the transported food product to the liquid and/or gaseous sanitizing material is increased by the continuous agitation of the transported food product in the auger system on a continuous basis. In one embodiment, a protein-based food product is provided to the auger system to enhance and continually sanitize using liquid and/or gaseous sanitizing material. The auger system includes specialized flights and attachments for the agitation and/or turning of the transported food product to affect the sanitizing process by exposing a substantial portion of the surface of the transported food product to the liquid and/or gaseous sanitizing material. Spray nozzles are provided to deliver the sanitizing material within the auger system and can be adapted to maximize the sanitizing process using a spray nozzle supply piping header. Blocking of certain areas of the surface of the transported food product is reduced or eliminated using the auger system which promotes exposure of the transported food product to the sanitizing material.

The process and apparatus of the present invention is not limited to protein-based food products as one of skill in the art would appreciate that other materials requiring the application of a gas or a liquid to affect the surface characteristics and surface chemistry of said material may benefit from the process and apparatus provided.

### BRIEF DESCRIPTION OF THE SEVERAL VIEWS OF THE DRAWINGS

The features and advantages of the present invention will become apparent from the following detailed description of a preferred embodiment thereof, taken in conjunction with the accompanying drawings, in which:

FIG. 1 shows the auger system in accordance with a preferred embodiment of the present invention.

### DETAILED DESCRIPTION OF THE INVENTION

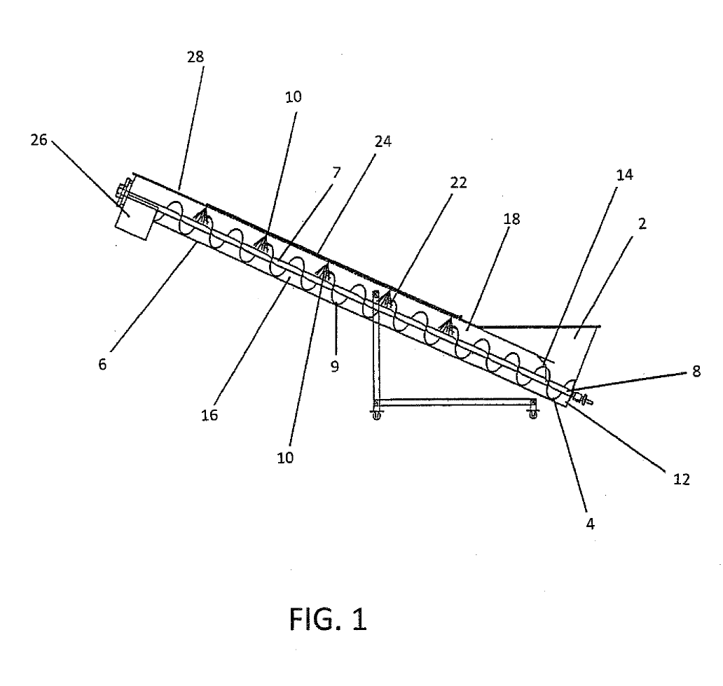

The auger system, as illustrated in FIG. 1, is designed to be utilized as a component part of a processing system whereby transported food product is transported from one process to another. When the processes located up-stream from the auger system process their material, it is delivered to an auger hopper 2. The auger hopper 2 is designed to accept the transported food product in a free fall fashion and acts as a collection bin and guide to ensure that the transported food product is fed into an auger collection slot 4 provided at an inlet side of an auger trough 6. The auger trough 6 houses an auger shaft and blade assembly 8 formed by a centrally located shaft 7 with helical flights attached to a helical flight of blades 9. The auger collection slot 4 is formed in the auger trough 6 and its total volume is determined by the design of the spacing and pitch of the blades 9 of the auger shaft and blade assembly 8. The auger collection slot 4 has a continual supply of sanitizing solution which forms as a pool from the sanitizing material flowing down the auger trough 6 when it is sprayed into the auger trough 6 by spray nozzles 10. When the transported food product is delivered to the auger hopper 2 it is guided down to the auger collection slot 4 where it is partially or totally submerged in the sanitizing solution provided at an inlet side of the auger shaft and blade assembly 8. This allows the transported food product to be pre-soaked in the sanitizing solution prior to being driven up the auger trough 6 by the rotating motion of the auger shaft and blade assembly 8. The volume of sanitizing solution in the auger collection slot 4 may be controlled by a drain slot and spill over damper assembly 12. The drain slot and spill over damper assembly 12 is designed to allow the motion of the transported food product to continually wipe the opening of the drain slot and keep the drain slots open for continual spill over of the sanitizing solution into the system drain as the transported food product is rotated by the motion of the auger shaft and blade assembly 8. This action will allow a user to set the depth of the pool of sanitizing solution in the auger collection slot 4 in a controlled manner.

The volume of transported food product delivered to the auger hopper 2 is variable and thus the total amount of transported food product that is collected in the auger collection slot 4 is based on the transported food product flow rate. In order to control the amount of transported food product that is allowed to be transported up the auger trough 6, a scraper plate 14 may be installed to scrape the top of the mass of transported food product that is above the scraper plate 14. This action will allow for the control of the volume of transported food product located in each processing slot 16 as the auger shaft and blade assembly 8 moves the mass of transported food product up the auger trough 6. The processing slot 16, as shown in FIG. 1, is generally defined as the space between adjacent blades 9 of the auger shaft and blade assembly 8.

If the volume of transported food product supplied to the auger hopper 2 is more than the material flow rate capabilities of the auger system, the auger trough 6 can be designed to allow for an increase in the diameter of the blades 9 of the auger shaft and blade assembly 8 as well as a subsequent and proportional increase in the diameter of the auger trough 6 to allow the processing slot 16 to be increased in volume, thus providing more open and free area 18 above the transported food product mass. The open and free area 18 is recommended in order to allow a spray nozzle 10 to provide a sanitizer spray pattern to disperse the liquid or gaseous sanitizing material to a wide area of the transported food product. The expansion of the diameter of the auger trough 6 and the subsequent increase in the diameter of the blades 9 of the auger shaft and blade assembly 8 can be a gradual increase with a tapered transition or it could be an abrupt transition. This increase in the diameter of the auger trough 6 and the diameter of the blades 9 of the auger shaft and blade assembly 12 can provide another area to locate a drain slot and spill over damper assembly to further provide a location for soaking the transported food product.

Due to the potential for flooding of the auger collection slot 4 and the possibility that the processing slots 16 will be completely filled with transported food product as the auger shaft and blade assembly 8 is rotated, the auger shaft and blade assembly 8 may be a two stage, single shaft having two sets of blades with different blade diameters. Each stage is located on a single auger shaft with the pitch of each stage being designed to enhance the transport and agitation of the sanitizing process. The first stage may have a smaller diameter blade with no added auger blade attachments or it could have a continuous blade diameter. This stage would be for loading of the auger collection slot 4 and is designed to pick up a full volume of transported food product from the auger hopper 2. This first stage of the auger shaft and blade assembly 8 could cover an area that begins at the very bottom of the auger hopper 2 and would end just beneath where the top of the hopper 2 connects to the top wall of the auger trough 6. An opening could be located at the bottom of the hopper 2 with the side walls of the hopper 2 being tapered towards the opening towards the auger collection slot 4 to ensure that the entire volume of the transported food product loaded in the hopper 2 will slide down to the auger collection slot 4. As the transported food product is loaded into one of the processing slots 16, formed by two adjacent blades and the side walls of the auger trough 6, from the hopper 2 the auger shaft and blade assembly 8 is rotated and the relative motion of the auger blades 9 imparts a force that pushes the loaded mass of transported food product up and into the auger trough 6 to a second stage of the auger shaft and blade assembly 8. Once the mass of transported food product is passed the top of the hopper 2, the diameter and/or pitch of the auger blades 9 may or may not be changed to allow for addition head space above the load of transported food product for increasing the auger system efficiency. This change in diameter of the auger blade 9 can either be abrupt or it can be accomplished at an increasing rate to form an angle in the auger trough 6 equal to the diameter change of the blade 9. This will ensure that the outer tip of the auger blade 9 and the auger trough 6 maintain a constant separation distance. In one embodiment, the separation distance is at least ⅙″ and up to 1″ or more depending on the material being transported and the need for water flow and draining. In any case, the separation distance between the auger blade 9 and the auger trough 6 should be such that the auger blade 9 and the auger trough 6 do not come in contact with one another without proper protection against metal-to-metal contact. During this transformation, the pitch of the auger blade 9 may be increased or remain the same depending on the transported food product being transported and in an effort to reduce the size of the mass of transported food product relative to the volume of each processing slot. This increase in volume as a result of increasing the diameter of the blade 9 will allow for a free area 18 to be created above the transported food product. At a certain distance from the diameter transformation length, which could be abrupt or gradual, the diameter of the auger blades 9 will remain constant all the way to the outlet side of the auger trough 6.

In prior auger transport applications, the material being moved is maintained in a mass form with very little disruption of the mass. In order to allow for a more complete coverage of the surfaces of the transported food product by the liquid or gaseous sanitizing material, the present auger system includes the mounting of an auger blade attachment 22 that acts as a material agitator. The auger blade attachment 22 is mounted on at least one blade of the auger shaft and blade assembly 8 and utilizes the rotational motion of the auger shaft and blade assembly 8 to move through the transported food product. The auger blade attachment 22 may be mounted on every blade or can be mounted on every other blade or can be mounted in any number of locations along the auger shaft and blade assembly 8 to affect the sanitizing and surface coverage action of the auger system. In one embodiment, the auger blade attachment 22 is attached near the outer edge of the blade 9 on the up-stream or down-stream side of the auger blade 9. The auger blade attachment 22 will rotate with the auger blade 9 and move in a circular motion around the auger trough 6 until it makes contact with the mass of transported food product. The auger blade attachment 22 moves under the mass of transported food product in a scooping fashion to disrupt the mass volume by lifting and moving the mass as the auger shaft and blade assembly 8 rotates. This motion as well as the design of the auger blade attachment 22 allows the mass of transported food product to be disrupted and stirred in the processing slot 16. The action of the auger blade attachment 22 as it is driven through the transported food product mass causes the mass to churn as the auger shaft and blade assembly 12 rotates.

The auger blade attachment 22 is designed to be product specific in that various geometries of product are envisioned as being affected by the disclosed invention and therefore each application of the invention will dictate how the auger blade attachment 22 should be designed to best suit the product agitation. If for example, the present auger system were to be utilized for the processing of poultry cuts such as chicken wings only, with their relatively small and uniform geometry, the auger blade attachment 22 would have a longer reach into the processing slot 16 with a tapered configuration set to ensure that the product does not get caught on the auger blade attachment 22 as it moves through the mass. If the product being processed is for example, turkey legs with their relatively larger size and geometry, the auger attachment blade 22 would be designed to incorporate a less gradual sweep into the mass with a more abrupt contact angle thus providing a larger degree of mass disruption. Other auger blade attachment 22 design features can be utilized to provide additional mass churn and disruption such as the addition of auger blade attachment 22 end wings that can be mounted at the end most section of the auger blade attachment 22 that provide a lifting feature for smaller or larger pieces of material. In all cases however, the auger blade attachment 22 would be modified to provide the proper churning of the product being processed without causing a large volume of the mass to be lifted and dumped into the downstream processing slot 16 but only imparting a mass disruption and churning effect to the mass of the product in the processing slot 16.

Located just above the auger blade attachment 22 and at specified angles relative to the location of the mass of transported food product are specialized liquid or gas fluid spray nozzles 10 providing a continual shower of liquid or gaseous sanitizing material which coats the exposed surfaces of the transported food product as it is disrupted and churned by the action of the auger blade attachment 22. It also causes skin flaps and surface cuts to be opened and exposed to the sanitizing material. The free area 18 provided between the auger trough 6 and the blades 9 allows for ample area for the rotation and churning of the transported food product and provides for ample area to allow the spray stream from the spray nozzles 10 to cover a larger area of the surface of the transported food product. The auger system includes at least one auger blade attachment 22 and spray nozzle 10. However, it is understood by those of skill in the art that a plurality of blade attachments 22 and spray nozzles 10 may be provided on the blades 9 and within the auger trough 6. In one embodiment, a plurality of auger blade attachments 22 and a series of spray nozzles are provided in a second stage of the auger shaft and blade assembly 8 as previously provided. By having a plurality of spray nozzles 10, the operator of the auger system may set the number of spray nozzles 10 that will be used at any given time to increase or decrease the coverage area of the transported food product. The spray nozzles 10 may be connected to a spray nozzle supply piping header 24 that has pre-selected control valves to allow the operator to control the number of spray nozzles 10 that are in use at any given time.

As the transported food product is moved up the auger shaft and blade assembly 8, it will be continually subjected to a spray of sanitizing material as the mass of transported food product is churned and turned. As the sanitizing material is sprayed, for example, in the case of a liquid sanitizing material, liquid will begin to fill the processing slots 16 which also contain the mass of transported food product. Various chemistries for use as liquid or gas sanitizing material can be utilized in the process. There are a very wide range of chemistries that have been approved for direct food contact by the USDA in the food industries and find application in their use in the present auger system. Several examples of these chemistries are peracetic acid based materials, chlorine based materials, bromine based materials, hydrogen peroxide, acetic acid to name a few. A typical example of a gaseous material that can be employed for application in the present auger system are ozone based materials as well as steam or any atomized form of the sanitizing liquids listed above. In any case, the USDA guidelines specify the particular liquid or gas that can be applied directly to the surface of a food product and therefore any of these approved products can be utilized in the present disclosed invention with a dramatically increased efficiency over static processes.

The liquid or gaseous sanitizing material sprayed from the spray nozzle 10 impacts the exposed surface areas of the transported food product and runs off the transported food product to collect at the bottom of the processing slot 16. This filling of each processing slot 16 is caused by the mass of transported food product blocking the exit area of each processing slot located at the clearance gap between the outer diameter of each blade 9 and the bottom of the auger trough 6. The sanitizing material is prevented from draining under and in between the clearance formed between the auger shaft and blade assembly 8 and the auger trough 6 by the blockage of the clearance by the mass of transported food product. This blockage and the build-up of sanitizing material allows for a pooling effect in each processing slot 16 which provides a soaking pool for the transported food product as it is moved up the auger trough 6 promoting more surface contact with the sanitizing material. When the auger shaft and blade assembly 8 continues to rotate, the auger blade attachment 22 moves up to the mass of transported food product and moves it in the direction of the rotation thus temporarily opening up the clearance between the auger blade 9 and the bottom of the auger trough 6. This allows previously supplied and pooled sanitizing material to be drained from an upper processing slot 16 to the previous processing slot. The previous processing slot 16 may or may not have a auger blade attachment 22 affixed to the blade 9 and thus the release of the pooled sanitizing material by the rotation of the auger shaft and blade assembly 8 from the upper processing slot 16 to the prior processing slot allows the sanitizing material to fill the prior processing slot with sanitizing material. This process continues up the entire length of the auger shaft and blade assembly 8 ensuring that a continual spray and immersion and draining action is seen in each processing slot 16 as the mass of transported food product is churned and turned. This intermittent cascading of the sanitizing material from the top of the auger trough 6 to the bottom of the auger trough 6 at the auger collection slot 4 is continual and provides a pool of sanitizing solution that is drained off as indicated above. This action allows the transported food product to be pre-soaked in the sanitizing solution before it is moved towards and under a sanitizing spray nozzle 10. It also allows the sanitizing material to remain in constant contact with the transported food product as it is moved up the auger trough 6.

As the volume of sanitizing material is eventually allowed to flow in an opposite direction to the flow of the transported food product, it eventually reaches the auger collection slot 4 at the inlet of the auger trough 6. Located within the auger collection slot 4 is the drain slot and spill over damper assembly 12 that includes a perforated or slotted drain section designed to provide a large drain area for the sanitizing solution to exit the auger trough 6. In one embodiment, the perforated or slotted drain section if formed from a metal material. In one embodiment, the perforation or slots are angled away from the direction of travel of the mass of transported food product to prevent excessive damage to the transported food product. In this embodiment, the perforation or slots have the blunt end of the tapered hole or slot facing the tangential direction of motion of the mass of transported food product as it is moved up the auger shaft and blade assembly 8 and thus the transported food product only contacts a tapered surface that does not shear the soft mass material of the transported food product as it is moved over the drain hole surface. In order to control the liquid pooling height of the sanitizing solution, the drain area may incorporate an adjustable drain damper that partially blocks the slotted or perforated drain holes to provide a dam type level control. The auger drain area may have a removable capture basin located on the outside, bottom side of the auger trough 6 to provide liquid capture in a controlled manner for proper draining to a plant water treatment facility.

In another embodiment of the invention, at least one drain slot can be provided in the bottom wall of the auger trough 6 positioned between the inlet side and the outlet side of the auger trough 6. In yet another embodiment, a plurality of drain slots can be provided in the bottom wall of the auger trough 6 positioned between the inlet side and the outlet side of the auger trough 6. The drain slot(s) provided between the inlet side and the outlet side of the auger trough 6 collect sanitizing material cascading toward the inlet side of the auger trough 6 prior to the sanitizing material reaching the inlet side of the auger trough 6. This feature allows the pooled sanitation material to be periodically drained off as the transported food product is moved up the length of the auger trough 6. This feature provides a food product dewatering action that enables the processor to control the amount of liquid sanitizing material that is allowed to be carried out of the auger discharge chute 26. The drain slot(s) can be positioned in any location along the length of the auger trough 6 to best affect the draining of the sanitizing material.

The sanitizing material is allowed to drain from the auger trough 6 in volumes that are set by the size of the processing slots 16 and their location along the length of the auger trough 6 to control the amount of sanitizing material that is carried out of the outlet side of the auger trough 6 with the transported food product that is being processed.

Once the transported food product is totally processed and has made it to the outlet side of the auger trough 6 by the rotational motion of the auger shaft and blade assembly 8, the transported food product will reach the edge of a discharge chute 26 where it will fall out of the auger trough 6. The transported food product may then be forwarded to another processing system downstream.

Located at the discharge chute 26, at least one additional discharge drainage slot can be implemented to enable the controlled drain and capture of residual liquid sanitizing materials as the transported food product is allowed to free fall into a downstream process. This discharge drainage slot is preferably mounted at an angle relative to the horizontal and is tapered towards the direction of travel of the transported food product being processed to ensure that the sanitizing material slides down the discharge drainage slot(s). Residual liquid is allowed to fall in between the discharge drainage slot(s) and be captured and collected for proper disposal.

The auger trough 6 may include an auger trough access door 28 that enables the operator to have complete access to the internal area of the auger trough 6 for cleaning and maintenance purposes. The spray nozzle supply piping header 24 may be affixed to a hinged or non-hinged access door 28 or could be mounted directly on the interior of the auger trough 6.

The auger system may include a ventilation system to control the pressure within the auger trough 6 to prevent over-spray and the escape of sanitizing gases or fumes.

Although the present invention has been disclosed in terms of a preferred embodiment, it will be understood that numerous additional modifications and variations could be made thereto without departing from the scope of the invention as defined by the following claims:

What is claimed is:

1. An auger system for sanitizing a transported food product comprising:
an auger trough having an inlet side, an outlet side, a top wall and a bottom wall;
an auger shaft and blade assembly provided within said auger trough, wherein said auger shaft and blade assembly includes a centrally located shaft attached to a helical flight of blades;
at least one spray nozzle provided at said top wall of said auger trough for distributing sanitizing material within said auger trough; and
at least one auger blade attachment provided on at least one blade of said helical flight of blades adapted to agitate the transported food product.

2. The auger system of claim 1, further comprising an auger hopper connected to said auger trough at said inlet side of said auger trough adjacent said top wall.

3. The auger system of claim 1, further comprising a drain slot and spill over damper assembly connected to said auger trough at said inlet side.

4. The auger system of claim 1, further comprising a scraper plate connected to said top wall of said auger trough at said inlet side.

5. The auger system of claim 1, wherein a free area is provided between said top wall of said auger trough and said helical flight of blades.

6. The auger system of claim 5, wherein said free area provides a clearance between said top wall of said auger trough and said helical flight of blades of ⅙ inch up to 1 inch.

7. The auger system of claim 1, further comprising a plurality of spray nozzles provided at said top wall of said auger trough for distributing sanitizing material within said auger trough.

8. The auger system of claim 7, wherein said plurality of spray nozzles is connected by a spray nozzle supply piping header.

9. The auger system of claim 1, further comprising a discharge chute at said outlet side of said auger trough.

10. The auger system of claim 1, further comprising an auger trough access door in said top wall of said auger trough.

11. The auger system of claim 1, further comprising a discharge chute provided at said outlet side of said auger trough, said discharge chute including at least one discharge drainage slot for separating sanitizing material from transported food product.

12. A method for sanitizing a transported food product comprising:
providing the auger system of claim 1;
feeding said transported food product to said auger trough at said inlet side;
moving said transported food product toward said outlet side of said auger trough by rotating said auger shaft and blade assembly;
supplying a sanitizing material to said transported food product through said spray nozzles such that said sanitizing material contacts a surface of said transported food product; and
collecting said sanitizing material between at least two adjacent blades of said auger shaft and blade assembly such that said transported food product may soak in said sanitizing material between said two adjacent blades.

13. The method of claim 12, wherein said transported food product is agitated by at least one auger blade attachment.

14. The method of claim 12, wherein said sanitizing material collected between at least two adjacent blades of said auger shaft cascades toward said inlet side of said auger trough forming a pool of sanitizing solution at said inlet side of said auger trough.

15. The method of claim 12, wherein said auger trough has at least one drain slot provided in said bottom wall located between said inlet side and said outlet said of said auger trough such that said drain slot collects said sanitizing material cascading toward said inlet side of said auger trough prior to said sanitizing material reaching said inlet side of said auger trough.

16. The method of claim 12, wherein said auger shaft and blade assembly includes a plurality of adjacent blades such that each of said adjacent blades forms a plurality of processing slots adapted to receive said transported food product and sanitizing material.

17. The method of claim 16, wherein said sanitizing material drains from said auger trough in volumes that are set by the size of said processing slots and the location of said processing slots along the length of the auger trough to control the amount of sanitizing material that is carried out said outlet side of said auger trough with the transported food product.

18. The method of claim 12, wherein said auger system further comprises a discharge chute provided at said outlet side of said auger trough, said discharge chute including at least one discharge drainage slot for separating said sanitizing material from said transported food product.

19. The method of claim 18, wherein said sanitizing material drains from said transported food product at said outlet side of said auger trough through said discharge drainage slots such that said sanitizing material is separated from said transported food product as said transported food product slides down said discharge chute in order to control the amount of sanitizing material that is carried out of the auger system with said transported food product to control the amount of said sanitizing material that is carried over to subsequent processing operations.
